(19) United States
(12) Patent Application Publication
(10) Pub. No.: US 2009/0246326 A1
(43) Pub. Date: Oct. 1, 2009

(54) COFFEE PRODUCT AND METHOD

(75) Inventors: Cynthia CARY, Benton, KY (US); Saundra KEELING, Benton, KY (US)

Correspondence Address: HUSCH BLACKWELL SANDERS LLP, 190 Carondelet Plaza, Suite 600, ST. LOUIS, MO, 63105, US

(73) Assignee: Empty Nest Ideas, LLC, Benton, KY (US)

(21) Appl. No.: 12/408,237

(22) Filed: Mar. 20, 2009

Related U.S. Application Data
(60) Provisional application No. 61/039,284, filed on Mar. 25, 2008.

(51) Int. Cl. A23F 5/12; A23F 5/38

(52) U.S. Cl. 426/93

(57) ABSTRACT

A coffee pill and method are provided. The coffee pill includes coffee encapsulated to prevent contact of the coffee product with the pallet during the initial stage of consumption by oral ingestion. Upon reaching the digestive tract, the encapsulant dissolves permitting the coffee product to be released from the pill.

### RELATED APPLICATIONS

This application is a non-provisional application claiming priority to provisional Patent Application Ser. No. 61/039,284 filed Mar. 25, 2008, the entire disclosure of which is incorporated herein by reference.

### BACKGROUND OF THE INVENTION

The consumption of coffee and coffee containing products is well known. Consumption is generally in the form of ingesting a brewed beverage which can be made from one of many varieties of coffee and can be ground roasted coffee or instant coffee. Coffee is also added to food products as an ingredient, usually as a flavorant permitting sensing of taste once the product reaches the mouth. Even some candies include coffee including whole roasted coffee beans. Coffee is processed prior to consumption, usually first by roasting the beans and then grinding. It may also be decaffeinated and some is made into instant coffee.

One of the benefits of consuming coffee is the intake of caffeine. However, many people do not like the taste of coffee but desire the caffeine and the temporary stimulation it provides. Robusta coffee, even though less expensive and higher in caffeine, has an even less liked taste. Additionally, many people who like coffee and the caffeine are not always at a place or at a time that coffee can be consumed in its normal form as a hot or even cold beverage.

There is thus a need for a way to consume coffee and its caffeine, avoid the taste and not have to brew a beverage with the resultant problems attendant with brewing and consuming a hot beverage. It is also desirable to consume coffee to obtain any health benefits from coffee while avoiding brewing and objectionable taste.

### SUMMARY OF INVENTION

The present invention involves the provision of a coffee product that may be ingested in a convenient dry form and avoid the taste of the coffee. The consumption of dry coffee avoids the necessity of having to have an apparatus for brewing the coffee, a cup and/or a hot water source to make the typical coffee beverage.

### DESCRIPTION OF THE DRAWINGS

FIG. 1 is a fragmentary side elevation and view of a coffee pill utilizing coffee particulates in a capsule.

FIG. 2 is an exploded view of the pill of FIG. 1.

FIG. 3 is a fragmentary side elevation view of a coffee pill utilizing coffee particulates formed into a solid tablet.

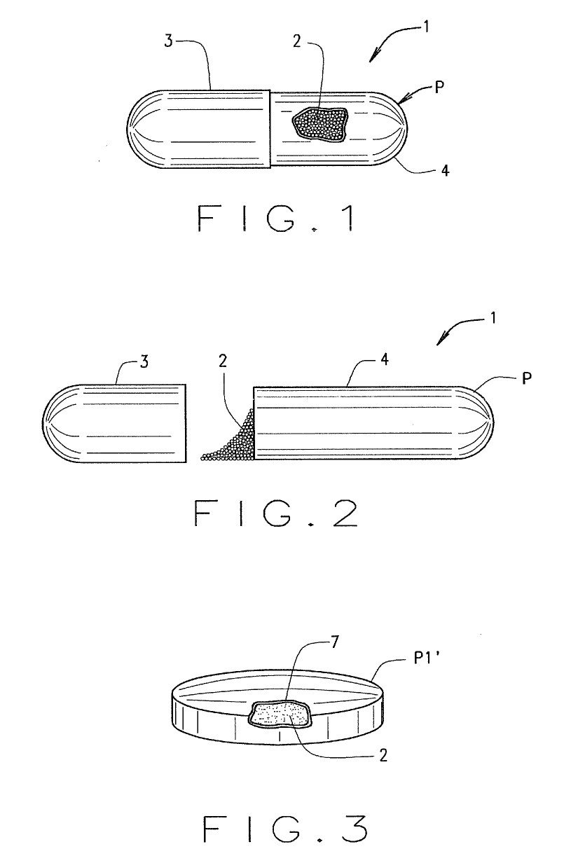

### DETAILED DESCRIPTION

The present invention relates to a coffee product in pill form. In a preferred embodiment, the pill P includes a capsule 1 which contains a particulate coffee product 2 inside the capsule to form a pill P. Preferably, the capsule 1 has two portions 3, 4 and is soluble after ingestion to release the coffee product 2 contained in the capsule 1. The capsule 1 encapsulates the coffee product 2. The contained coffee product 2 is released after the pill P has passed through the oral cavity. Preferably, the capsule 1 is of the size 00 or smaller and may be made of a soluble material such as gelatin. The capsule 1 may be vegetable (e.g. methylcellulose or spun protein) as well animal based and may be flavored if desired. Such capsules typically come in two parts 3, 4 and can be filled with a dry particulate coffee (regular or instant). Particulate coffee powder is known in the art and can be instant coffee or ground coffee (roasted or unroasted). Preferably, each capsule 1 will contain in the range of between about 0.2 grams and about 0.4 grams of coffee product 2 and at least about 20 milligrams of caffeine per pill P. When utilizing uncompressed coffee, it has been found that a dosage of approximately one teaspoon of finely powdered instant coffee can be delivered in four 00 size capsules which is equivalent to about one cup of coffee. Preferably, the coffee product 2 is instantized water soluble coffee. Preferably the coffee product 2 is finely ground.

The coffee product 2 may also be pressure formed to form a solid tablet of the particulates by using suitable binders and a suitable pressure forming method as are known in the art. The pressure formed material may be delivered in a soluble capsule or may be a tablet coated (encapsulated) with a soluble coating material 7 to prevent coffee in the pill P′ of FIG. 3 from dissolving for a period of time adequate to permit swallowing while avoiding the taste of the coffee product 2.

It is has been found, that by use of the present invention, Robusta coffee can be utilized while avoiding its objectionable taste. Robusta coffee typically has a much higher caffeine content than other types of coffee and is less expensive. If one is desirous of a higher concentration of caffeine, Robusta would be a coffee of choice except for its taste. Preferably, the coffee product 2 includes at least a majority by weight Robusta derived coffee product. The present invention allows for the consumption of Robusta coffee while avoiding its objectionable taste. Additionally, if higher concentrations of caffeine are desirable, caffeine can be added to the coffee product 2 which could reduce the number of pills needed to be consumed to get to the desired amount of caffeine.

By use of the present invention, the consumption of the coffee product 2 avoids staining of the teeth, clothing, countertops and the beverage container used to serve a typical coffee product. The present invention also provides a way of consuming coffee that avoids the taste particularly of objectionable coffee varieties like Robusta as well as avoiding coffee breath. The present invention can be used at any time, anywhere, requires no liquid or heating device to brew a beverage, prevents burning of the consumer in the event that a hot coffee beverage is spilled. The present invention also provides some of the positive benefits of antioxidants along with the ingestion of caffeine which cannot be provided with caffeine pills. There are studies suggesting health benefits for coffee including a reduction in the risk of developing Parkinson's disease.

The present invention provides a coffee product in a convenient pill form allowing the consumption of the coffee product at any time with no taste or requiring the use of water and a container to consume. Preferably, a pill of the coffee product 2 provides coffee in weight range on a dry weight basis, in the range of between about 0.2 grams and about 0.4 grams and preferably in the range of between about 0.25 grams and about 0.35 grains of coffee product per tablet. Caffeine is preferably present in a pill P, P′ in an amount of at least about 20 milligrams and more preferably at least about 25 milligrams of naturally present caffeine.

The method of the present invention involves the ingestion of a coffee product 2 in dry encapsulated form which retards dissolution of the encapsulant (capsule 1, coating 7) during normal consumption prior to the tablet reaching the digestive tract of the consumer. Preferably, the pill P, P′ is provided in a form that keeps all the coffee encapsulated prior to reaching the digestive tract by the pill having a capsule or coating that is at least substantially imperforate at the start and initial stage of ingestion.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present invention will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. An ingestible pill of coffee product comprising:
ground coffee product having at least about 20 milligrams of caffeine; and
a soluble substantially imperforate encapsulant enclosing the coffee product.

2. The coffee product of claim 1 wherein the ground coffee being in an amount of between about 0.2 grams and about 0.4 grams.

3. The coffee product of claim 1 wherein the encapsulant including a soluble capsule.

4. The coffee product of claim 1 wherein the coffee product being in tablet form and the encapsulant including a soluble coating on the tablet.

5. The coffee product of claim 1 wherein the coffee product including Robusta coffee.

6. The coffee product of claim 1 wherein the coffee product including instant coffee.

7. The coffee product of claim 1 wherein the coffee product including roasted coffee.

8. A method of consuming caffeine by a human, the method including:
providing a pill of coffee product wherein the coffee product having at least about 20 milligrams of caffeine and a substantially imperforate encapsulant enclosing the coffee product; and
ingesting the pill.

9. The method of claim 8 wherein the coffee product being in particle form and the encapsulant including a soluble capsule.

10. The method of claim 9 wherein the coffee product including instant coffee.

11. The method of claim 8 wherein the coffee product being in tablet form and the encapsulant including a soluble coating on the tablet.

12. The method of claim 8 wherein the coffee product including at least a majority Robusta derived coffee product.
